(19) United States
(12) Patent Application Publication
(10) Pub. No.: US 2012/0124570 A1
(43) Pub. Date: May 17, 2012

(54) METHOD AND SYSTEM FOR FACILITATING THE PROVIDING OF SOFTWARE UPDATES TO MOBILE DEVICES

(75) Inventors: William P. Alberth, JR., Prairie Grove, IL (US); Patricia A. Robb, Prairie Grove, IL (US)

(73) Assignee: MOTOROLA MOBILITY, INC., LIBERTYVILLE, IL (US)

(21) Appl. No.: 12/947,413

(22) Filed: Nov. 16, 2010

(51) Int. Cl. G06F 9/44

(52) U.S. Cl. 717/173

(57) ABSTRACT

A method and system for facilitating updating of software programming on a plurality of mobile devices are disclosed. In one embodiment, the method includes receiving at a server, from the mobile devices, first information regarding usage of at least one feature at the mobile devices. The method further includes recognizing at the server that a software update is available, and determining an ordering of at least some of the mobile devices, the ordering taking into account the first information. Additionally, the method also includes sending the software update for receipt by each of the at least some mobile devices so that the software update can be implemented thereon, where the sending proceeds at least partly based upon the ordering.

### CROSS-REFERENCE TO RELATED APPLICATIONS

N/A

### STATEMENT REGARDING FEDERALLY SPONSORED RESEARCH OR DEVELOPMENT

N/A

### FIELD OF THE INVENTION

The present invention relates to communications involving mobile devices and, more particularly, to communications with mobile devices by which the mobile devices are provided with updates to software implemented on the mobile devices.

### BACKGROUND OF THE INVENTION

Mobile devices such as cell phones, personal digital assistants (PDAs), and smart phones operate by way of a variety of software programs (understood herein to be synonymous with the term software applications) implemented thereon. Given the number and complexity of the software programs implemented on mobile devices, as well as the ongoing development of new and/or improved programs to be run on mobile devices, there is often a desire that one or more of the existing software program(s) implemented on a given mobile device be updated to accommodate modifications of a variety of types or to supplement the existing program(s) with additional programs.

Commonly, software updates are provided to mobile devices by way of the wireless carriers operating the wireless networks with which those mobile devices are in communication (the wireless carriers can thus also be referred to as mobile telecommunication network operators). While software updates can be successfully communicated to mobile devices in this manner, this conventional manner of providing software updates is often inefficient. To begin with, various software updates can often take anywhere from one to ten minutes to complete. While the software updating is occurring, the mobile device is precluded from performing (or beginning to perform) a variety of other activities, and particularly precluded from engaging in operations involving communications via the same network over which software update(s) are being received.

Further, to the extent that a given mobile device is already performing other activities when the wireless carrier attempts to commence a software update, the performing of the software update will need to be deferred and reattempted at a later time when the mobile device is not busy. Because it typically is desired that a given software update be commonly applied to multiple (e.g., many thousands of) mobile devices as part of a network-wide rollout of the update, in practice it can often take a long period of time (e.g., two days) for a wireless carrier to successfully apply the update in relation to all of the mobile devices for which that update is intended, as the carrier must often reattempt the application of the update on numerous occasions with respect to the many mobile devices.

In view of the above, it would therefore be advantageous if improved systems and/or improved methods for providing (or facilitating the providing of) software update(s) to one or more mobile device(s) can be developed.

### SUMMARY OF THE INVENTION

In at least one embodiment, the present invention relates to a method of facilitating updating of software programming on a plurality of mobile devices. The method includes receiving at a server, from the mobile devices, first information regarding usage of at least one feature at the mobile devices. The method also includes recognizing at the server that a software update is available, and determining an ordering of at least some of the mobile devices, the ordering taking into account the first information. The method further includes sending the software update for receipt by each of the at least some mobile devices so that the software update can be implemented thereon, where the sending proceeds at least partly based upon the ordering.

Additionally, in at least one embodiment, the present invention relates to a system for facilitating updating of software programming on a plurality of mobile devices. The system includes a first server having a processing device and at least one memory device, where the server operates to communicate with the mobile devices. The first server particularly is configured to operate so that, upon receiving a plurality of information portions respectively provided from the plurality of mobile devices indicative of operational behavior of the mobile devices, and further receiving software update information including a first software update, the first server develops a priority listing of at least some of the mobile devices, and subsequently sends the first software update to the at least some mobile devices in a manner based at least in part upon the priority listing.

Further, in at least one embodiment, the present invention relates to a method of facilitating updating of software programming on a plurality of mobile devices. The method includes receiving at a server first information from the mobile devices, the first information regarding operational behavior of the mobile devices, and storing on the at least one memory device of the server second information pertaining to a first software update to be implemented on at least one of the mobile devices. The method additionally includes processing the first and second information to determine an ordering of at least some of the mobile devices of the plurality of mobile devices, and sending, based at least in part upon the ordering, the software update for receipt by each of the at least some mobile devices so that the software update can be implemented thereon.

### BRIEF DESCRIPTION OF THE DRAWINGS

FIG. 1 shows in schematic form an example communications system involving a plurality of mobile devices in communication with potential sources of software update information (among other types of information), by way of an intermediary server;

FIG. 2 is a block diagram showing example components of one of the mobile devices of FIG. 1;

FIG. 3 is a block diagram showing example components of the intermediary server of FIG. 1; and

FIG. 4 is a flow chart showing various example steps of operation of some of the components of the system of FIG. 1, by which a software update can be implemented on the mobile devices, in at least some embodiments.

### DETAILED DESCRIPTION

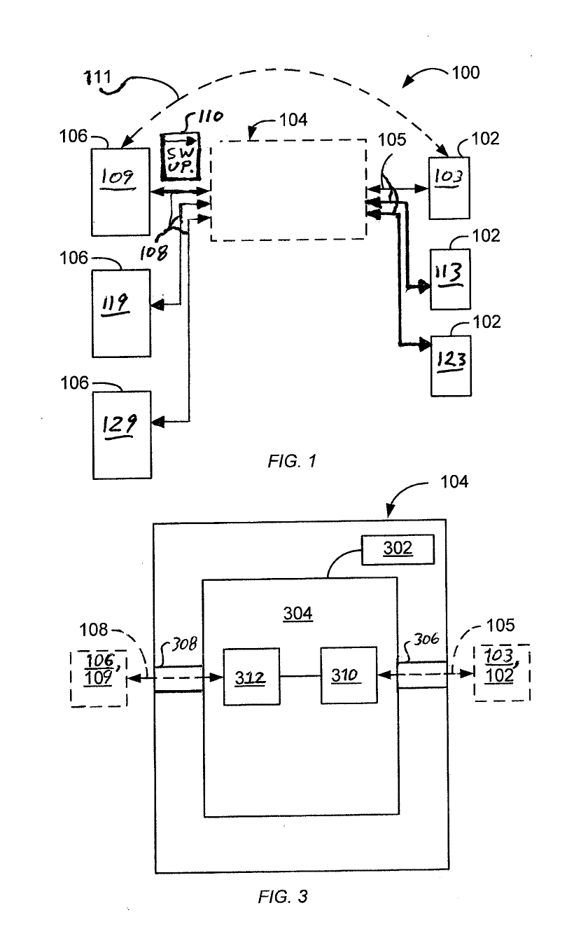

Referring to FIG. 1, a block diagram of an example communications system 100 is shown in a simplified schematic form. As shown, the communications system 100 includes in this embodiment three mobile devices 102, particularly including first, second, and third mobile devices 103, 113, and 123, respectively. As shown, each of the mobile devices 102 is in (or is capable of) communication via a respective communication link 105 with a server, which in the present embodiment is a web server 104 (e.g., a server that supports internet protocols or otherwise is capable of interaction with the internet or World Wide Web). The mobile devices 102 are respectively representative of communication devices operated by persons (or users) or possibly by other entities (e.g., other computers) desiring or requiring communication capabilities. In some embodiments, for example, the mobile devices 102 can be any of cellular telephones, personal digital assistants (PDAs), smart phones, other handheld or portable electronic devices, headsets, MP3 players, battery-powered devices, wearable devices, radios, navigation devices, laptop or notebook computers, netbooks, pagers, PMPs (personal media players), DVRs (digital video recorders), gaming devices, cameras, netbooks, e-readers, e-books, tablet devices, navigation devices with video capable screens, multimedia docking stations, or other mobile devices.

The communications system 100 in the present embodiment additionally includes three additional servers 106, particularly including first, second, and third additional servers 109, 119, and 129, respectively. As shown, each of the additional servers 106 is in communication with (or capable of communication with) the intermediary web server 104 via a respective communication link 108. The additional servers 106 in the present embodiment are intended to represent any of a variety of servers (or, indeed, other types of computer systems) that are capable of providing various types of information for receipt by the mobile devices 102 and/or receiving various types of information provided by the mobile devices.

As represented by way of the communication links 108, 105, in the present embodiment communications between one or more of the additional servers 106 and one or more of the mobile devices 102 occurs via the web server 104 operating as an intermediary therebetween. As will be discussed in further detail below, the web server 104 particularly provides various functionality that enhances the process of implementing software updates on one or more of the mobile devices 102. Notwithstanding the presence of the web server 104, as represented by an additional communication link 111, it is still possible that one or more of the mobile devices 102 will communicate directly with one or more of the additional servers 106 directly, that is, without intermediation by the web server 104.

In the present embodiment, more particularly, it can be assumed that at least the first additional server 109 (if not two or all three of the additional servers 106) is capable of supplying information regarding one or more software updates to be implemented upon one or more of the mobile devices 102. The first additional server 109 can be considered, for example, a server associated with a manufacturer of one or more of the mobile devices 102 from which software updates are provided on a continual (or nearly continual), periodic (e.g., annual or semiannual), or occasional basis. Alternatively, the first additional server 109 supplying information regarding software update(s) to be implemented upon one or more of the mobile devices 102 can be a server associated with a wireless carrier, or a server associated with the author of a software program already resident on the mobile device that the software update(s) are intended to upgrade.

It should be added that the additional servers 106 can further provide, in addition to software updates themselves, indications as to which of several available software updates already provided to the mobile devices 102 (or at least to the web server 104) should be executed or otherwise implemented at given times, indications as to which mobile devices (or types of mobile devices) the software updates pertain to, and/or indications that one or more software update(s) are now available for implementation.

Although embodiments of the present invention are particularly directed toward the providing of software updates to mobile devices, not all of the additional servers 106 shown in FIG. 1 need to be sources of such software updates. Rather, in at least some embodiments, one or more of the additional servers 106 (e.g., the second and third additional servers 119, 129) instead provide and/or receive other types of information. For example, in some embodiments, one or more of the additional servers 106 are servers hosting content provider websites (CPWs), which can be understood to generally encompass any of a variety of types of websites including, for example, social networking websites (SNWs), business-to-business websites, business-to-consumer websites, news feeds, video broadcast or other broadcast sources, music and photograph websites, or other sources of media content. Further for example, such CPWs can include Facebook™, MySpace™, hi5™, LinkedIn™, and Twitter™, youtube.com, hulu.com, as well as sources of RSS or other news feeds, photograph services such as Picasa™ or Photobucket™, and music services such as LastFM™.

Further, although FIG. 1 shows the web server 104 to be potentially in communication with multiple (e.g., three) of the additional servers 106 as well as three of the mobile devices 102, this illustration is merely one example. In other embodiments, any arbitrary number of mobile devices, ranging from one mobile device to many hundreds or thousands (or more) of mobile devices, can be in communication with the web server 104 and can be intended recipients of a given software update or software update(s). Also, in some of the embodiments, any arbitrary number of additional servers (or other computer systems or terminals or information sources) can provide software updates intended for implementation on any such arbitrary number of mobile devices, and/or can otherwise be in communication with such arbitrary number of mobile devices. Further it should be understood that, in some embodiments, it is possible that certain software update(s) will be provided from one of the additional servers 106 (such as the first additional server 109) while other software update(s) will be provided from others of the additional servers (such as the additional servers 119, 129).

Additionally, in some embodiments the web server 104 itself can be the source of one or more software update(s) such that the web server fulfills two roles, namely, operating as a source of software update(s) and also operating as an intermediary between one or more of the additional servers 106 and one or more of the mobile devices 102. For example, just as the first additional server 109 can be a computer system affiliated with a manufacturer of the mobile devices 102 that is providing software updates, likewise the web server 104 itself can be a computer system affiliated with such a manufacturer that serves this purpose.

Depending upon the embodiment, the communication links 105, 108, 111 can be part of a single network or multiple networks, and each link can include one or more wired and/or wireless communication pathways, for example, landline (e.g., fiber optic, copper) wiring, microwave communication, radio channel, and/or wireless path, etc. In the present embodiment, it is particularly envisioned that the communication links 105, 108, 111 involve internet, intranet, and/or World Wide Web communication pathways (which themselves can employ numerous intermediary hardware and/or software devices including, for example, numerous routers, etc.). In addition, a variety of communication protocols and methodologies can be used to conduct the communications via the communication links 105, 108, 111 between the mobile devices 102, web server 104, and additional servers 106, including for example, transmission control protocol/internet protocol (TCP/IP), extensible messaging and presence protocol (XMPP), file transfer protocol (FTP), etc. In other embodiments, other types of communication links for facilitating the communication of signals between the plurality of mobile devices 102 and the additional servers 106 can be utilized as well. In particular, although in the present embodiment the communication links (network) 105 and 108 and server 104 are each discussed as being web-based, in other embodiments, these links (network) and server can assume various non-web-based forms.

As already mentioned and as discussed in further detail below, the web server 104 particularly operates to communicate software update(s) to one or more of the mobile devices 102, where the software update(s) are provided to the web server from one or more of the additional servers 106 (e.g., the first additional server 109) and/or originate at the web server itself. Further, various other types of communications between the mobile devices 102 and additional servers 106 are passed through, processed and/or monitored by the web server 104. Such communications can include, for example, communications involving the uploading and downloading of files (e.g., photos, music, videos, text entries, etc.), blog postings, and messaging (e.g., Short Message Service (SMS), Multimedia Messaging Service (MMS), and Instant Messaging (IM)). Also, in some embodiments, streaming video and/or audio information can be communicated from the additional servers 106 to the mobile devices 102.

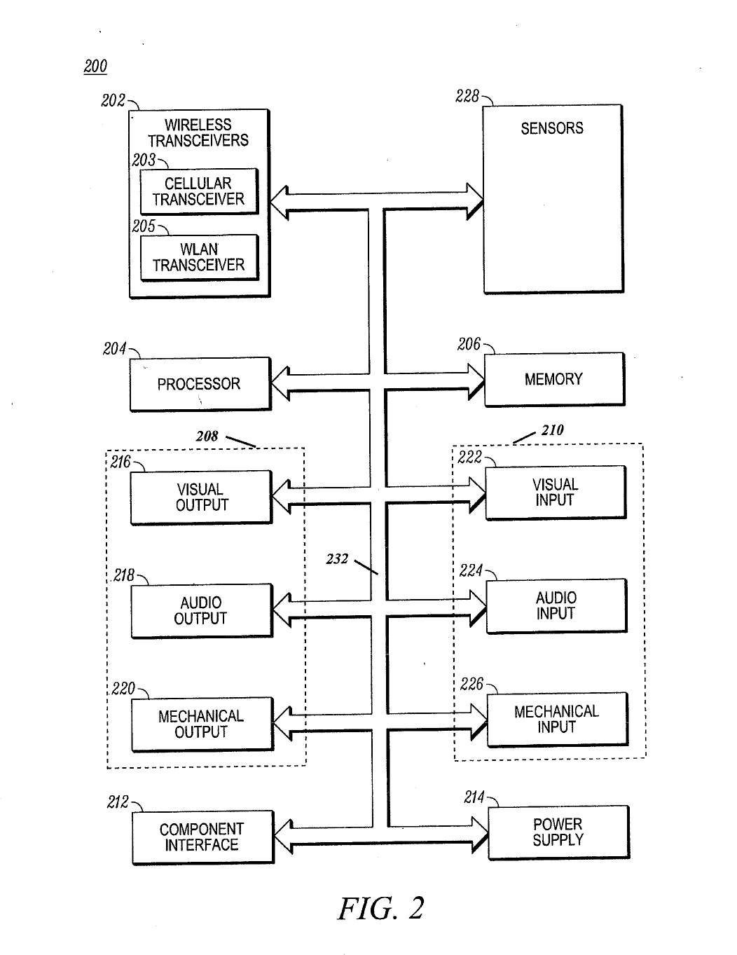

Referring to FIG. 2, there is provided a block diagram illustrating example internal components 200 of the first mobile device 103 of FIG. 1, in accordance with the present embodiment. It should be understood that it is possibly the case, albeit not necessarily the case, that these internal components are also present in one or more of the other ones of the mobile devices 102 of FIG. 1, and not just the first mobile device 103. As shown in FIG. 2, the internal components 200 include one or more wireless transceivers 202, a processor 204 (e.g., a microprocessor, microcomputer, application-specific integrated circuit, etc.), a memory portion 206, one or more output devices 208, and one or more input devices 210. In at least some embodiments, a user interface is present that comprises one or more of the output devices 208, such as a display, and one or more of the input devices 210, such as a keypad or touch sensor.

The internal components 200 can further include a component interface 212 to provide a direct connection to auxiliary components or accessories for additional or enhanced functionality. The internal components 200 preferably also include a power supply 214, such as a battery, for providing power to the other internal components while enabling the mobile device to be portable. Further, the internal components 200 additionally include one or more sensors 228. All of the internal components 200 can be coupled to one another, and in communication with one another, by way of one or more internal communication links 232 (e.g., an internal bus).

Each of the wireless transceivers 202 utilizes a wireless technology for communication, which can include for example (but are not limited to) cellular-based communication technologies such as analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF (radio frequency), Bluetooth or IEEE 802.11(a, b, g or n), or other wireless communication technologies such as infrared technology. In the present embodiment, the wireless transceivers 202 include a cellular transceiver 203 and a wireless local area network (WLAN) transceiver 205, although in other embodiments only one of these types of wireless transceivers (and possibly neither of these types of wireless transceivers, and/or additional types of wireless transceivers) is present.

By virtue of the use of the wireless transceivers 202, the first mobile device 103 is capable of communicating with the web server 104 (e.g., by way of its respective communication link 105) and thus capable of communicating indirectly with each of the additional servers 106. Further by virtue of the use of the wireless transceivers 202, the first mobile device 103 also is capable of communicating directly with the additional servers 106 (such as the first additional server 109) by way of direct communication link(s) such as the communication link 111.

Operation of the wireless transceivers 202 in conjunction with others of the internal components 200 of the first mobile device 103 can take a variety of forms. For example, operation of the wireless transceivers 202 can proceed in a manner in which, upon reception of wireless signals, the internal components 200 detect communication signals and the transceivers 202 demodulate the communication signals to recover incoming information, such as voice and/or data, transmitted by the wireless signals. After receiving the incoming information from the transceivers 202, the processor 204 formats the incoming information for the one or more output devices 208. Likewise, for transmission of wireless signals, the processor 204 formats outgoing information, which can but need not be activated by the input devices 210, and conveys the outgoing information to one or more of the wireless transceivers 202 for modulation so as to provide modulated communication signals to be transmitted. The wireless transceivers 202 convey the modulated communication signals by way of wireless (as well as possibly wired) communication links such as the communication links 105, 111 to other devices such as the web server 104 and one or more of the additional servers 106 (as well as possibly to other devices such as a cell tower, access point, or another server or any of a variety of remote devices).

Depending upon the embodiment, the input and output devices 208, 210 of the internal components 200 can include a variety of visual, audio and/or mechanical outputs. For example, the output device(s) 208 can include one or more visual output devices 216 such as a liquid crystal display and/or light emitting diode indicator, one or more audio output devices 218 such as a speaker, alarm, and/or buzzer, and/or one or more mechanical output devices 220 such as a vibrating mechanism. The visual output devices 216 among other things can also include a video screen. Likewise, by example, the input device(s) 210 can include one or more visual input devices 222 such as an optical sensor (for example, a camera lens and photosensor), one or more audio input devices 224 such as a microphone, and/or one or more mechanical input devices 226 such as a flip sensor, keyboard, keypad, selection button, navigation cluster, touch pad, capacitive sensor, motion sensor, and/or switch. Operations that can actuate one or more of the input devices 210 can include not only the physical pressing/actuation of buttons or other actuators, but can also include, for example, opening the mobile device, unlocking the device, moving the device to actuate a motion, moving the device to actuate a location positioning system, and operating the device.

As mentioned above, the internal components 200 also can include one or more of various types of sensors 228. The sensors 228 can include, for example, proximity sensors (e.g., a light detecting sensor, an ultrasound transceiver or an infrared transceiver), touch sensors, altitude sensors, and one or more location circuits/components that can include, for example, a Global Positioning System (GPS) receiver, a triangulation receiver, an accelerometer, a tilt sensor, a gyroscope, or any other information collecting device that can identify a current location or user-device interface of the mobile device 102. While the sensors 228 for the purposes of FIG. 2 are considered to be distinct from the input devices 210, in other embodiments it is possible that one or more of the input devices can also be considered to constitute one or more of the sensors (and vice-versa). Additionally, while in the present embodiment the input devices 210 are shown to be distinct from the output devices 208, it should be recognized that in some embodiments one or more devices serve both as input device(s) and output device(s). For example, in embodiments where a touchscreen is employed, the touchscreen can be considered to constitute both a visual output device and a mechanical input device.

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. In some embodiments, the memory portion 206 can be integrated with the processor 204 in a single device (e.g., a processing device including memory or processor-in-memory (PIM)), albeit such a single device will still typically have distinct portions/sections that perform the different processing and memory functions and that can be considered separate devices. The data that is stored by the memory portion 206 can include, but need not be limited to, operating systems, programs (applications), and informational data. Each operating system includes executable code that controls basic functions of the mobile device, such as interaction among the various components included among the internal components 200, communication with external devices via the wireless transceivers 202 and/or the component interface 212, and storage and retrieval of programs and data, to and from the memory portion 206.

As for programs, each program includes executable code that utilizes an operating system to provide more specific functionality, such as file system service and handling of protected and unprotected data stored in the memory portion 206. Although many such programs govern standard or required functionality of the mobile device, in many cases the programs include applications (or simply “apps”) governing optional or specialized functionality, which can be provided in some cases by third party vendors unrelated to the mobile device manufacturer. Although it is possible in some embodiments for the operating system (or portions thereof) of a mobile device to be updated by way of one or more software updates provided to the mobile device, typically it is the one or more programs stored in the memory of the mobile device that are updated by way of software updates provided to the mobile device. In some cases, software updates provided to a mobile device result in the addition of entirely new programs being added to (stored on) the mobile device.

Finally, with respect to informational data, this is non-executable code or information that can be referenced and/or manipulated by an operating system or program for performing functions of the mobile device. Among other things, informational data can include any of a variety of types of information that is uploaded to, downloaded from, or otherwise accessed at the web server 104 or one or more of the additional servers 106 with respect to which the mobile device is in communication. Although not typically the case, in some circumstances it is possible that informational data is received or modified when a software update is implemented on the mobile device.

Referring next to FIG. 3, example components of the web server 104 of FIG. 1 are shown in more detail. As shown, the web server 104 includes a memory portion 302, a processor portion 304 in communication with that memory portion, and first and second input/output (I/O) interfaces 306 and 308, respectively, for interfacing the communication links 105 and 108, respectively, with the processor portion 304. In at least some embodiments including the present embodiment, the web server 104 can also be understood to serve as an aggregation server insofar as the web server keeps track of and aggregates (and stores in the memory portion 302) a variety of information that relates to communications and other activity of the mobile devices 102. Further as discussed below, the web server 104 can also store in the memory portion 302 one or more software updates that are to be provided to one or more of the mobile devices 102. In the present embodiment, one or more of the software update(s) particularly are received by the web server 104 from the first additional server 109, albeit in other embodiments software update(s) can be received from the others of the additional servers or other sources (or originate at the web server itself).

As additionally shown in FIG. 3, the processor portion 304 further includes a front end portion 310 and a back end portion 312. The back end portion 312 communicates with the additional servers 106 such as the first additional server 109 (shown in dashed lines) via the respective communication links 108 (one of which is shown) and the second I/O interface 308. In some embodiments, particularly where the additional servers 106 are SNWs, the back end portion 312 can be referred to as a “Social Network Processor”. Additionally, the front end portion 310 communicates with the mobile devices 102 such as the first mobile device 103 (also shown in dashed lines) via the respective communication links 105 (again one of which is shown) and the first I/O interface 306. In view of the above discussion, it should be understood that the front end portion 310 can be in communication with any arbitrary number of mobile devices and that the back end portion 312 can be in communication with any arbitrary number of additional servers, depending upon the embodiment.

In at least some embodiments the back end portion 312 supports pull communications with the additional servers 106 such as the first additional server 109. The pull communications can for example be implemented using Representation State Transfer (REST) architecture, of the type typical to the web. Assuming this to be the case, the back end portion 312 is configured to generate requests for information to be provided to the back end portion from the additional servers 106 (such as the first additional server 109) at times/circumstances determined by the web server 104, in response to which the additional servers search for and provide back to the web server requested data. Also, in at least some embodiments the front end portion 310 supports push communications in conjunction with the mobile devices 102 such as the first mobile device 103. In this regard, it should be understood that an arbitrary number of push channels can be established with respect to the various mobile devices 102. In the present embodiment, it is also envisioned that in at least some circumstances push channel(s) will be established and utilized to communicate software updates to one or more of the mobile devices 102. By comparison, although it is possible that pull channels can be established between the web server 104 and the additional servers 106 by which the web server obtains relevant software updates from the additional servers, in the present embodiment such pull channels are not used for this purpose, but rather the timing of the providing of software updates to the web server from the additional servers is determined by the additional servers themselves.

The server 104 discussed with reference FIGS. 1 and 3 can take various forms depending upon the implementation or embodiment. In at least some circumstances, the server 104 discussed with reference to FIGS. 1 and 3 can be considered a cloud. Further, although FIGS. 1 and 3 show the single server 104, it should be understood that in other embodiments there can be more than one intermediating device constituting a cloud (or implemented in place of the server 104) including, for example, a collection of multiple servers that are in communication with one another and that, in at least some embodiments, support Internet technologies for communication between computer systems and/or other entities.

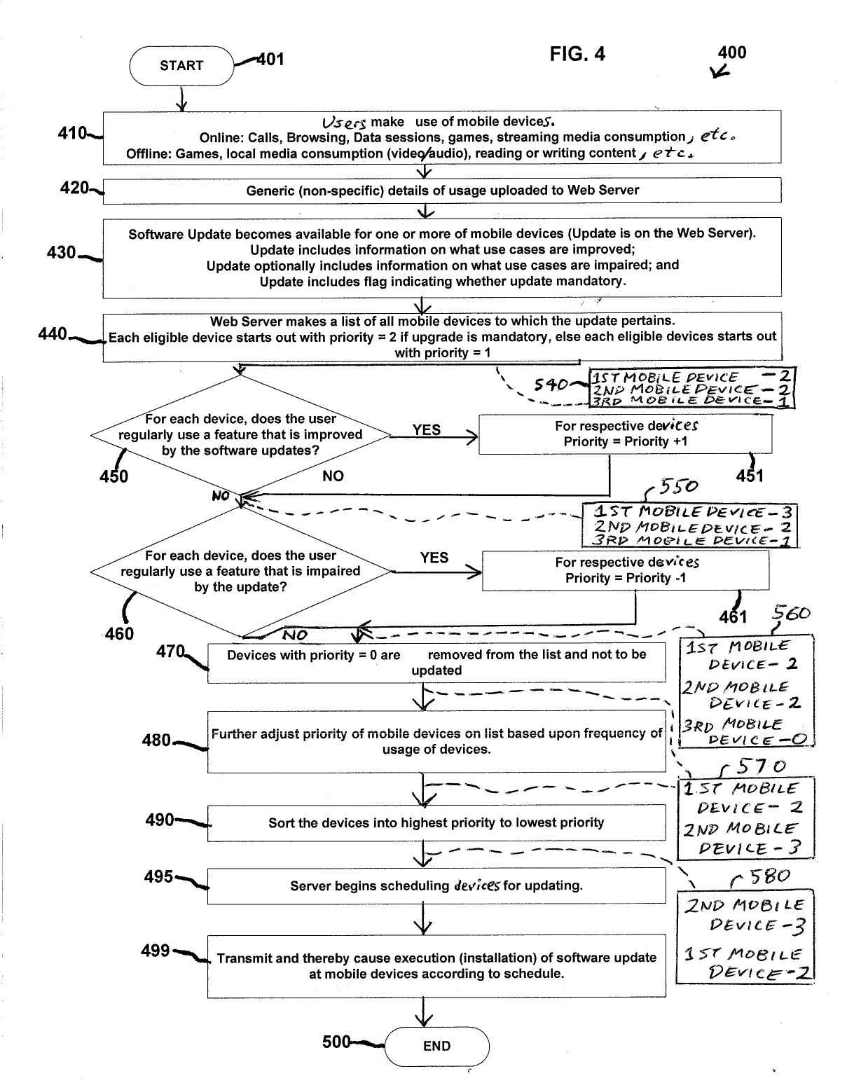

Turning now to FIG. 4, a flow chart 400 shows an example operational process of at least some portions of the system 100 of FIG. 1, and particularly illustrates an example operational process by which a software update or upgrade is provided to multiple mobile devices such as the mobile devices 102 by the web server 104 in a manner that takes into account historic behavior of the mobile devices so as to result in a more timely and efficient implementation of the software update than might otherwise occur.

As shown, the process represented by the flowchart 400 begins at a start step 401 followed by a step 410, at which users (e.g., persons) make use of the mobile devices 102 in any of a variety of matters. For example, such usage can involve online activity of the mobile devices 102 involving the receipt or transmission of wireless signals, such as engaging in telephone (e.g., voice or video) calls, browsing activity, engaging in data sessions, communicating data such as email or text messages, online gaming, streaming (e.g., video or audio) media consumption, navigating, etc. Alternatively, or in addition, the usage of the mobile devices 102 can include offline activities that do not require communication by the respective mobile device with any external entities, such as offline gaming, local media consumption (for example, listening to a video or audio recording that is already stored on the mobile device), managing contacts, taking photographs using an on-board camera, reading content stored on the mobile device, or writing content onto the mobile device without transmitting that content outside of the mobile device. With respect to reading and writing content, such activity can involve the offline review or creation of word processing documents, Powerpoint slide shows, email message, or other documents, for example.

As represented by additional step 420, after the users make use of the mobile devices in the step 410, the mobile devices 102 communicate with the web server 104 and provides to the web server generic (that is, non-specific) details of the usage of the mobile devices. Although FIG. 4 shows the step 420 as occurring subsequent to the step 410, it will be understood that the actual uploading of information from the mobile devices 102 to the web server 104 can occur at a variety of times and in a variety of manners including, for example, ongoing or continual uploading of information as the mobile devices are used, periodic uploading of information at different times as the mobile devices are used, or either after a given amount of usage has occurred or after all usage has occurred. In some embodiments, information regarding the usage of one mobile device (e.g., the first mobile device 103) will be uploaded before usage of others of the mobile devices (e.g., the mobile devices 113, 123) has even occurred (and thus before uploading of any information regarding that usage). The uploaded information can be stored in the memory portion 302 of the web server 104.

The information that is uploaded to the web server 104 at the step 420 in the present embodiment is kept non-specific for various reasons, for example, a desire to avoid communicating to the web server certain types of information that may be considered by some individuals to be personal or private, a desire to avoid communicating to the web server certain information that by convention or practice is typically retained at a mobile device, and/or a desire to avoid communicating excessive amounts of information to the web server. Nevertheless, a variety of types of information can be provided at the step 420 depending upon the embodiment or circumstance. Also, the types of information that are withheld by the mobile devices 102 and not provided to the web server 104 can also vary depending upon the embodiment or circumstance.

For example, in one embodiment, the information provided to the web server 104 in the step 420 can include information as to the amount of time (e.g., one hour per day) that a user on average utilizes the first mobile device 103 to browse websites and/or information regarding the typical or average time of the day when browsing occurs. However, the first mobile device 103 does not provide to the web server 104 at the step 420 information regarding the particular websites that were the subject of the browsing by the user. Also, in another embodiment, the mobile device 103 can provide to the web server 104 information regarding the time or amount of time that the user of the mobile device streams media (e.g., because a user prefers to watch a particular television program every week at the same time). However, in such case, the mobile device 103 does not provide to the web server 104 details of the particular content reviewed by the user.

Further for example, in another embodiment the first mobile device 103 can send information to the web server 104 indicating when a user of the mobile device tends to make phone calls and approximately on average how long the phone calls last. In such case, however, the mobile device 103 does not share with the web server 104 any information indicative of the people with whom the user was connected by way of the mobile device 103 (e.g., no phone number information). In yet another example, the first mobile device 103 can provide an indication to the web server 104 that the mobile device is generally idle between 1 pm and 6 pm (which might be indicative of the fact that the user works third shift). Also, for example, the mobile device 103 can provide to the web server 104 information that a media player of the mobile device is active from midnight to 1 am. Again, in such circumstance, a mobile device 103 would refrain from indicating more specific information about the use of the media player, such as information regarding the content that was played using the media player.

Based upon the various information provided from the mobile devices 102 to the web server 104, the web server is able to store within its memory portion 302 the information and develop a history of usage patterns of the mobile devices 103, for example, in terms of the features or functions that the users of the mobile devices are activating, how often such features are active, and/or the times of day that those features tend to be active. Thus, the web server 104 is able to take this information into account in terms of how it operates to cause installation or implementation of software update(s) 110 in relation to the mobile devices 102. Although the information can be taken into account in a variety of ways depending upon the embodiment, steps 430-499 illustrate in further detail one example manner in which the web server 104 takes such information into account in determining how to proceed with installing or implementing software update(s) onto the mobile devices 102.

Referring particularly to a step 430 in this regard, in the present example the web server 104 begins the process of determining how to proceed with installing/implementing (and ultimately installing/implementing) a software update when the web server receives software update information including such a software update, e.g., when the web server receives the software update 110 of FIG. 1 and stores that information in the memory portion 302. In the present embodiment the software update 110 is provided from the first additional server 109, which is associated with the manufacturer of the mobile devices 102 (although, as already discussed, the software update can also come from any of a variety of other sources as well, such as a wireless carrier or author(s) of applications to which the software update pertains).

In determining how to proceed with installing/implementing the software update 110, the web server 104 among other things first can take into account information pertaining to the software update itself, which can be provided along with the actual software update programming as supplemental software update information (the software update 110 can be considered to include both the actual software update programming and such supplemental software update information). For example, typically, the software update 110 is pertinent to particular mobile devices or types of mobile devices rather than all devices that might potentially be in communication with the web server 104. Thus, the software update 110 can include information indicating the mobile device or types of mobile devices that should receive the software update (albeit for purposes of the present example, it will be assumed that all of the mobile devices 102 in communication with the web server 104 would be suited for the software update 110). Also, the software update 110 can include information regarding which problems are to be fixed by installation of the software update, information regarding requirements as to whether one or more previous software updates need to have been installed prior to the installation of the present update, or information regarding what type of network (or network characteristics) should be present in order for the software update to be properly implemented.

As shown in the step 430, in the present embodiment the software update 110 particularly includes information regarding what operational features, use cases, or performance characteristics of the mobile devices 102 (and/or software programs resident thereon) will be (or are likely to be) improved by implementing the software update on the mobile devices 102. Correspondingly, the software update 110 also includes information regarding what mobile device operational features, use cases, or performance characteristics will be (or are likely to be) impaired due to implementation of the software update on the mobile devices 102. Further, the software update 110 additionally includes information (e.g., a flag) indicative of whether installation of the software update is mandatory or optional. As discussed further below, in the present embodiment, this information regarding operational improvement and impairment resulting from implementation of the software update 110, and the mandatory/optional nature of the software update, is particularly utilized by the web server 104 in determining how to install/implement the software update in relation to the mobile devices 102.

Next, at a step 440, the web server 104 utilizes the information regarding the software update 110 received at the step 430 to make a list of all of the mobile devices 102 to which the new software update 110 pertains (this can also be thought of as a list of users that have devices that are candidates to receive the software update). Assuming more than one mobile device is eligible (e.g., all three of the mobile devices 102), then the list in particular is a priority list, where the web server 104 assigns priority levels for each of the eligible mobile devices 102. The manner of prioritization can vary depending upon the embodiment or circumstance.

In the present embodiment, for example, the web server 104 assigns a priority level of two (2) to each respective one of the mobile devices 102 for which implementation of the software update 110 is mandatory, and assigns a priority level of one (1) to each respective one of the mobile devices for which implementation of the software update is optional. For example, the priority list can take the form shown as a block 540 in FIG. 4, which shows each of the first mobile device 103 and the second mobile device 113 as having a priority level of two (2) indicating that the software update is mandatory for those mobile devices, while the third mobile device 123 has a priority level of one (1) indicating that the software update is optional for that mobile device.

Next, at a step 450, the web server 104 further determines, for each of the eligible mobile devices 102, whether that respective mobile device (or the user of that mobile device) regularly or typically uses a feature that will be (or is likely to be) improved by the software update 110. This can be determined based upon the details of usage that were uploaded at the step 420. That is, the web server 104 can check the history recorded in the memory portion 302 reflective of the details of usage of each of the mobile devices 102 and compare the typically used features to the features that the software update 110 will (or is likely to) improve as indicated of the step 430.

As further shown, if a given one of the mobile devices 102 such as the first mobile device 103 typically uses a feature that will be improved by the software update 110, then at a step 451 the priority level of that mobile device is increased by one (1) prior to the process advancing to a step 460. Thus, if the first mobile device 103 was originally assigned a priority level of two (2), then upon execution of the step 451, the priority level for that mobile device is increased to three (3). Alternatively, if the feature that is improved by the software update 110 is not among the features regularly used at the first mobile device 103, then the web server 104 does not adjust the priority level of that mobile device and rather the process advances directly from the step 450 to the step 460.

Further, at the step 460, for each of the eligible mobile devices 102, the web server 104 also determines whether that respective mobile device regularly uses a feature that will be (or is likely to be) impaired or degraded by the software 110 update. To make this determination, the web server 104 again consults the information stored in the memory portion 302 that was obtained at the step 420, and compares the features typically used by each of the mobile devices 102 with the features that the software update 110 will (or is likely to) impair or degrade. If at the step 460 it is determined that one or more of the feature(s) that will be (or are likely to be) impaired by the software update 110 are one or more of the features that are typically used by a given one of the mobile devices 102 such as the first mobile device 103, then the process advances to a step 461, at which the priority level of that respective mobile device is reduced by one (1). Upon completion of the step 461, or if at the step 460 it is determined that the one or more feature(s) that will be (or are likely to be) impaired by the software update 110 are not among the features that are typically used by the given mobile device, then the process advances to a subsequent step 470.

In regards to the steps 450-461, it should be further noted that these steps are intended to be performed in relation to each respective eligible one of the mobile devices 102. Thus, notwithstanding the particular manner of illustration of these steps in FIG. 4, in practice where more than one eligible mobile device is present, the steps 450-461 can each be performed on multiple occasions with respect to each mobile device. Also, while the steps 451 and/or 461 can be performed in relation to certain of the mobile device(s) if determined to be applicable at the steps 450 and 460 when performed in relation to those device(s), the steps 451 and 461 need not be performed in relation to every one of the eligible mobile device(s) if those steps are not pertinent to those device(s).

As a result of the performing of the steps 450-461, the priority levels associated with the different eligible ones of the mobile devices 102 may have changed. For example, as shown in FIG. 4, after the performing of the steps 450-451 with respect to each of the mobile devices 102, assuming that the first mobile device 103 regularly utilizes a feature that is to be improved by the software update 110 but the second and third mobile devices 113, 123 do not, then the priority listing can have changed from that shown in the block 540 to that shown in a block 550 (where the priority level of the first mobile device in particular is shown to have increased by one (1)). Further for example, after the performing of the steps 460-461 with respect to each of the mobile devices 102, assuming that each of the first and third mobile devices 103, 123 regularly use a feature that is to be impaired by the software update 110 but the second mobile device 113 does not, then the priority listing can have changed from that shown in the block 550 to that shown in a block 560 (where the priority levels of each of the first and third mobile devices are shown to have decreased by one (1)).

Referring next to the subsequent step 470, the web server 104 reviews the priority levels (as adjusted by way of the steps 450-461) of the mobile devices 102 on the list of eligible mobile devices and removes from that list all of the mobile devices that have a priority level of zero (0). From the above discussion, it will be apparent that a given one of the mobile devices can attain a priority level of zero in regards to the implementation of the software update 110 if several conditions are met, namely, that (a) the software update 110 is optional rather than mandatory as determined at the step 440, (b) the software update will not (or is not likely to) improve a regularly-used feature (or feature(s)) of the mobile device as determined at the step 450, and (c) the software update will (or is likely to) impair a regularly-used feature (or feature(s)) of the mobile device as determined at the step 460 such that the priority level of the mobile device is further adjusted downward at the step 461. It should be evident that, if all of these three conditions are met with respect to the given one of the mobile devices 102, then it makes sense to avoid installing the software update 110 onto that mobile device, since fulfillment of all of these conditions indicates that the software update is not necessary and potentially does more harm than good in terms of improving those aspects of the performance of that mobile device that are of the greatest interest to the user of that mobile device.

Upon completion of the step 470, the web server 104 at an additional step 480 further considers information (again as uploaded at the step 420) regarding the frequency of usage of those of the mobile devices 102 that are still listed as eligible, and adjusts the priority levels of those mobile devices in a manner that is reflective of the frequency usage information. It will be understood that it is desirable to adjust priority levels based upon frequency of usage because, by making such adjustments, it is possible to then (as discussed further below) implement the software update 110 across the mobile devices on the network in a manner that favors those of the mobile devices that are more heavily used and thereby will receive more benefit from the software updates.

The manner of adjusting priority levels based upon frequency usage information can vary depending upon the embodiment. For example, in some embodiments, priority levels of the mobile devices 102 are simply increased by amounts corresponding to their respective frequency of usage levels, with those of the mobile devices having higher-frequency usage levels receiving greater increases in their priority levels than those of the mobile devices having lower-frequency usage levels. Also, in some embodiments, the frequencies of multiple different types of mobile device usage can be taken into account in determining priority level. In some such embodiments, the frequency of usage information regarding multiple different types of usage of a mobile device can all be taken into account (and weighed relative to one another) in determining the mobile device's overall frequency of usage. In other embodiments, each different type of frequency of usage information can separately be used as a basis for making an adjustment to the priority level of the mobile device.

For example, the priority level of a mobile device can be adjusted to reflect each of the mobile device's data communication levels, voice communication levels, and text messaging levels. Further for example, if the mobile device uses greater than 100 Megabytes per month in terms of data communications, and also uses at least 2000 minutes per month for voice communications, the priority level of the mobile device can be increased to three (3). However, if the mobile device uses only at least 2000 minutes per month for voice communications but conducts no data communications, then the priority level of the mobile device can be increased to two (2). Further, if the mobile device sends 1000 short messaging service (SMS) transmissions per month, the priority level of the mobile device can also be increased by one (1) for that reason. Again notwithstanding these examples, the particular changes in priority level that are provided to reflect frequency of usage can vary depending upon the embodiment or circumstance.

Regardless of the particular frequency of usage information taken into account, and the manner in which frequency of usage information is taken into account, upon completion of the step 480 the priority level assignments of the various eligible units of the mobile devices 102 have been set. For example, due to the performing of the steps 470 and 480, the priority listing shown in the block 560 can have been modified to that shown in a block 570. As shown in the block 570 more particularly, the priority listing as a result of the step 470 no longer includes any listing of the third mobile device 123 since that mobile device had attained a priority level of zero (0) following the step 461, and also the priority listing shows the second mobile device 113 to have an increase priority level of three (3) assuming that, at the step 480, it was determine that the second mobile device had a higher frequency of usage level than the first mobile device 103.

Given the setting of the priority levels for each of the remaining eligible ones of the mobile devices 102 (namely, the first and second mobile devices 103 and 113), following the step 480 at a step 490 the web server 104 then sorts the remaining eligible mobile devices so as to be ordered in accordance with their respective priority levels, e.g., from the mobile device with the highest priority level to the mobile device with the lowest priority level. For example, assuming the previous block 570 as a starting point, the sorting process performed at the step 490 would result in a final priority list shown in a block 580 in which the second mobile device 113 (with its higher priority level of three (3)) is ranked higher than the first mobile device 103 (with its lower priority level of two (2)).

Subsequently, at a step 495 the web server 104 begins scheduling the eligible mobile devices 102 for updating. In the present embodiment, the scheduling takes into account not only the priority levels assigned to the different ones of the mobile devices 102, but also takes into account historical usage information (again as was received at the step 420) as to when each of the mobile devices is typically used, so as to avoid scheduling installation of the software update 110 on a given one of the mobile devices at time(s) when that mobile device is typically using the network (e.g., the respective communication link 105) for other purposes. In at least some cases, notwithstanding a particular prioritization of the mobile devices as arrived at by way of the steps prior to the step 490, usage information can trump the prioritization.

For example, even if the second mobile device 113 has a higher prioritization than the first mobile device 103 as shown in the block 580, the web server 104 can schedule the sending of the software update 110 to the first mobile device 103 at a time earlier than the sending of the software update to the second mobile device 113 if the web server 104 determines that the overall process of transmitting the software update should occur at midnight on a given day and yet usage information regarding the second mobile device 113 shows that it is typically unable to receive such a software update transmission at midnight.

After the scheduling operation at the step 495 has been performed, then at a step 499 the web server 104 transmits the software update 110 to, and thereby causes execution (installation) of the software update on, the various eligible ones of the mobile devices 102 in accordance with the established schedule. In the present embodiment (although not necessarily the case in all embodiments), the transmission of the software update 110 to the eligible ones of the mobile devices 102 occurs by way of one or more push channels formed via the communication links 105, and achieved using the front end portion 310 of the web server 104. Subsequent to the sending (and consequent implementation) of the software update 110 at the step 499, the process ends at an end step 500.

Further with respect to the sending of the software update 110 at the step 499, it can further be noted that, although in some embodiments it is possible that software update 110 will be installed on each of the mobile devices 102 immediately upon the transmission of the software update to the respective mobile devices, this need not always be the case. Rather, in other embodiments, the software update 110 can be transmitted to the mobile devices 102 at particular time(s) determined by the schedule established at the step 495, and then installed at other later time(s) determined by the respective mobile device(s) independently (or also possibly partly in accordance with the schedule established at the step 495). Such a two-part installation procedure can be particularly advantageous to the extent that it allows the software update process to proceed even when certain circumstances arise that might otherwise impede the updating process.

For example in this regard, a given software update can be sent to a mobile device (e.g., the first mobile device 103) at a time when the mobile device is being operated in an “off-line” capacity, or in some other capacity not involving communications over the wireless network by which the software update is to be transmitted to the mobile devices (e.g., operated to display a movie being streamed over Wi-Fi). In such circumstance, it would be appropriate for the transmission of the software update to occur, given that the transmission via the network would not interrupt any other operations. Additionally, in such circumstance, it would also be appropriate for installation to be delayed until the off-line (or other) operation of the mobile device ceased or was reduced sufficiently to allow the installation of the software update to proceed uninhibited (e.g., unimpeded by other demands upon the processor 204 of the mobile device). Subsequently, at the time of installation, network communication is no longer needed to conduct the installation of the software update but rather the process can be completed independently by the mobile device itself without further involvement by the web server 104.

Additionally for example, it is sometimes the case that network transmission quality varies with location, e.g., a user typically charges a mobile device at a location with poor network service. Given a two-part installation procedure as discussed above, it is possible for a software update to be transmitted at a time other than while the mobile device is being charged (e.g., at a time when there is good transmission quality but the mobile device is not otherwise being utilized to conduct communications via the network), and then for the software update to be installed while the mobile device is being charged and otherwise not being used.

Notwithstanding the above description, it is envisioned that the present invention can encompass numerous other embodiments besides those particularly discussed above. For example, the arrangement of steps shown in the flow chart 400 of FIG. 4 can vary depending upon the embodiment (e.g., the step 480 in which priority level is adjusted to reflect frequency of usage information could precede the steps 450-470). Also for example, in some alternate embodiments, one or more of the steps of the process represented by the flow chart 400 need not be present, and/or one or more other steps can be added to the process. For example, in additional alternate embodiments, the web server 104 can prioritize implementation of a given software update based upon the type of mobile device (e.g., cellular telephones can be prioritized higher than personal digital assistants).

Also, notwithstanding the description provided above, the particular comparisons or other operations performed by the web server 104 in performing prioritization can take a variety of other forms. For example, while priority levels are described above as being increased at the step 451 and decreased at the step 461, respectively, in other embodiments the priority levels can be increased when it is determined that a feature will be impaired by a software update and decreased when it is determined that a feature will be enhanced by a software update. Also for example, while a priority level of zero is discussed above as being grounds for removal of a mobile device from a priority list, in other embodiments the satisfaction of other priority levels or thresholds serves as a basis for removal or inclusion. Further, even though the above description particularly concerns the transmission of software updates, similar actions can be taken to communicate backup information or other types of information (including other types of information to be pushed) to mobile devices as well.

It should be noted that the above-discussed procedures are advantageous in that the procedures in at least some embodiments can allow for software updates (and other information) to be provided to and implemented on mobile devices not only with minimal interruption (or no interruption) to mobile device users but also in an entirely or substantially automatic manner with no user inputs or permissions required. Nevertheless, in other embodiments the process can be configured to require and/or take into account particular user inputs and/or permissions. For example, in some such alternate embodiments, if the web server 104 determines that a particular time would be particularly beneficial for implementing a software update but that particular time appears to coincide with a time that a given mobile device is typically used in a manner that would preclude receipt of the software update, the web server 104 can send an inquiry to the given mobile device in an attempt to obtain permission from the mobile device user to go ahead with the software update notwithstanding the past history of usage.

Additionally, while the above-discussed embodiments particularly involve the implementation of software updates on mobile devices, in other embodiments the same or similar techniques can be utilized to implement software updates on other electronic devices instead of, or in addition to, mobile devices.

Thus, it is specifically intended that the present invention not be limited to the embodiments and illustrations contained herein, but include modified forms of those embodiments including portions of the embodiments and combinations of elements of different embodiments as come within the scope of the following claims.

1. A method of facilitating updating of software programming on a plurality of mobile devices, the method comprising:
receiving at a server, from the mobile devices, first information regarding usage of at least one feature at the mobile devices;
recognizing at the server that a software update is available;
determining an ordering of at least some of the mobile devices, the ordering taking into account the first information; and
sending the software update for receipt by each of the at least some mobile devices so that the software update can be implemented thereon,
wherein the sending proceeds at least partly based upon the ordering.

2. The method of claim 1, wherein the respective mobile devices of the at least some mobile devices are arranged in the ordering at least in part based upon respective priority levels.

3. The method of claim 2, wherein at least one of the priority levels depends upon whether the software update is mandatory or optional.

4. The method of claim 2, wherein at least one of the priority levels depends upon whether an operation of a first feature of the at least one feature used by at least one of the mobile devices will be affected by an implementation of the software update.

5. The method of claim 4, further comprising changing a first of the priority levels pertaining to a first of the mobile devices if it is determined that the operation of the first feature on the first mobile device will be affected by the implementation of the software update on the first mobile device.

6. The method of claim 5, wherein the changing of the first priority level includes one or both of (i) modifying the first priority level if it is determined that the operation of the first feature will be enhanced by the implementation of the software update, or (ii) adjusting the first priority level if it is determined that the operation of the first feature will be degraded by the implementation of the software update.

7. The method of claim 2, wherein the server is a web server including a push capability, and wherein the sending of the software update proceeds by way of at least one push channel.

8. The method of claim 2, further comprising determining that one of the mobile devices of the plurality of mobile devices has a first priority level that either meets or fails to meet a threshold and, upon doing so, removing the one mobile device from the ordering, wherein the at least some mobile devices does not include the one mobile device.

9. The method of claim 2, further comprising modifying at least some of the priority levels of the at least some mobile devices based upon frequency of usage information pertaining to the at least some mobile devices.

10. The method of claim 9, wherein the frequency of usage information includes one or more of first usage information pertaining to voice communications usage, second usage information pertaining to data communications usage, and third usage information pertaining to short message communications usage.

11. The method of claim 2, wherein the ordering includes a priority list.

12. The method of claim 1, wherein the sending is based upon a schedule dependent at least partly upon the ordering.

13. The method of claim 1, further comprising receiving software update information including the software update from a third party source, and wherein the received software update information includes one or more of first information indicating whether the software update is mandatory or optional, second information indicating whether the software update will improve or is likely to improve a performance of at least one operational feature, and third information indicating whether the software update will degrade or is likely to degrade the performance of the least one operational feature.

14. The method of claim 1, wherein the receiving of the first information includes receiving of one or more of an indication of an average amount of time that a first feature is actuated on one of the mobile devices, and an indication of an average time of day that the first feature is actuated on the one mobile device.

15. The method of claim 1, the first information including data concerning when one or more of the mobile devices have been used, wherein at least one send time of day at which the sending of the software update occurs is at least in part determined to avoid at least one other time of day when the one or more of the mobile devices have historically been used as indicated by the data.

16. A system for facilitating updating of software programming on a plurality of mobile devices, the system comprising:
a first server having a processing device and at least one memory device,
wherein the server operates to communicate with the mobile devices, and
wherein the first server particularly is configured to operate so that, upon receiving a plurality of information portions respectively provided from the plurality of mobile devices indicative of operational behavior of the mobile devices, and further receiving software update information including a first software update, the first server develops a priority listing of at least some of the mobile devices, and subsequently sends the first software update to the at least some mobile devices in a manner based at least in part upon the priority listing.

17. The system of claim 16, wherein the first server additionally operates to communicate with at least one additional system, and wherein the first server receives the first software update from the at least one additional system.

18. The system of claim 17, wherein the priority listing is stored in the at least one memory device of the server, and wherein the at least one additional system includes at least one content provider website.

19. A method of facilitating updating of software programming on a plurality of mobile devices, the method comprising:
receiving at a server first information from the mobile devices, the first information regarding operational behavior of the mobile devices;
storing on the at least one memory device of the server second information pertaining to a first software update to be implemented on at least one of the mobile devices;
processing the first and second information to determine an ordering of at least some of the mobile devices of the plurality of mobile devices; and
sending, based at least in part upon the ordering, the software update for receipt by each of the at least some mobile devices so that the software update can be implemented thereon.

20. The method of claim 19, wherein the processing to determine the ordering includes one or more of: (a) adjusting a priority ranking based upon frequency of usage information included in the first information; (b) adjusting the priority ranking based upon third information included in the second information, the third information concerning whether the software update is mandatory or optional; and (c) adjusting the priority ranking based upon fourth information included in the second information, the fourth information concerning whether the software update is likely to enhance or impair one or more operations of at least one of the mobile devices if implemented thereon.
